(19) United States
(12) Patent Application Publication
(10) Pub. No.: US 2022/0210981 A1
(43) Pub. Date: Jul. 7, 2022

(54) Method For Optimizing Growth Of Microgreens

(71) Applicant: John Paul D'Acquisto, Pismo Beach, CA (US)

(72) Inventor: John Paul D'Acquisto, Pismo Beach, CA (US)

(21) Appl. No.: 17/570,105

(22) Filed: Jan. 6, 2022

Related U.S. Application Data
(60) Provisional application No. 63/134,258, filed on Jan. 6, 2021.

(51) Int. Cl. A01G 7/04; A01G 9/24; A01G 31/02

(52) U.S. Cl. CPC A01G 7/045; A01G 31/02; A01G 9/249

(57) ABSTRACT

A method for optimizing growth of microgreens is provided. The method includes planting individual microgreens within growing racks supported on vertically spaced shelves or on a common height on a single horizontal shelf. An ideal distance is calculated for the spacing of the vertical shelves when using fixed wattage grow lights, and an ideal wattage is calculated for one or more grow lights, which may be LEDs. Adjustable wattage grow lights may be utilized for a common height setup. An ideal wavelength range is also applied, for enhancing desired colors in the final product. The microgreen seeds are planted in an organic nutrient solution derived from ocean water. A natural fungicide including ingredients such as molasses and lactic acid is applied, which allows room temperature to be raised to a calculated level, allowing for increased growth rates and yield without development of unwanted fungi.

### BACKGROUND OF THE INVENTION

The present invention relates to plant cultivation. More specifically, the present invention provides a method for optimizing the growth of microgreens, particularly with regard to calculation of an ideal light distance, light intensity, light duration, and temperature level, in order to increase yield, improve hardiness, enhance color patterns, improve taste, and provide an overall improved product.

Microgreens are vegetable or herb greens that are harvested prior to full growth at the seedling stage. Specifically, a microgreen is a vegetable green that has been harvested just after the cotyledon leaves have developed, usually when there is just one pair of young “true” leaves. Growing microgreens allows individuals to grow small vegetable seedlings on large or very small scales. The ability to grow on a small scale provides the individuals with the convenience to grow these types of plants in any environment. Microgreens can grow under various lighting conditions, including under indirect natural light, artificial lights, or in complete darkness. The different lighting conditions can allow the microgreens to grow easily in most environments, and the chances in lighting conditions can also cause the microgreens to have different flavors and significantly different appearances when they are grown.

Microgreens have become increasingly popular worldwide. Their small size allows them to be cultivated in nearly any environment, allowing for control over lighting conditions and other parameters. As such, there is fierce competition in the microgreens industry and each grower is looking for an innovative method to grow better looking and tasting microgreens to put themselves above the competition. Microgreens often contain higher nutrient concentrations than when the plant is fully grown. As such, they are consumed increasingly for their nutritional value. Microgreens are also often used to enhance a visual aspect or textural aspect of a food dish. For example, microgreens are used as garnishes atop a finished dish to enhance its presentation. Given the most popular uses of microgreens, it is important for growers to maximize both the nutritional quality and aesthetic aspects of the finished product. For example, the color and consistency of the microgreen stem and leaves is important, since they are often use for visual appeal. In view of the above concerns, the present invention provides a method for optimizing growth of microgreens that provides for improved color, yield, taste, and overall quality of the microgreen product.

Methods for growing microgreens exist, but they have several drawbacks and room for improvement. There has been a distinct lack of innovation in terms of using grow lights to their full potential in the microgreens industry. Most growers dismiss higher powered lights due to the higher likelihood of them burning microgreens. A possible solution to this problem is to place the lights further away from the microgreen, or at a calculated distance the increases growth rate and yield without burning. An issue presented is that an increase distance between the light source and the microgreen can reduce the amount of vertical shelf space available to the grower. A restriction on vertical shelf space can reduce the number of microgreens that can be grown, and ultimately reduce the amount that can be sold to consumers. One alternative that microgreen growers choose to use as a light source is a low powered LED. The use of low powered LEDs allows for multiple shelves to be stacked closely together. However, the low powered LEDs does not optimize the growth of the microgreens.

Other issues arise in such high moisture growing environments, where microgreens can be susceptible to fungi. When the soil-borne fungi are grown on the microgreens, it can kill or stunt the growth of microgreens. Providing users with a method for optimizing growth of microgreens that also includes natural fungicides to prevent the growth of fungi will lead to a higher yield for the microgreens. The present invention provides users with a method designed to maximize vertical grow space, while also maximizing the strength of light delivered to the microgreens on a per species basis. The present method is also flexible in that it can be utilized in different setups, such as a common-height setup where every plant is on the same horizontal plane. In such setups, the method allows for the adjustment of the LED output according to particular species and desired growth outcomes.

In light of the needs disclosed in the known art, it is submitted that the present invention substantially diverges from the known art and consequently it is clear that there is a need in the art for an improvement to existing microgreen growing methods, particularly with regard to the above-described need for improving growth rates, yields, taste, color, and other qualities. In this regard the present invention substantially fulfills these needs.

### SUMMARY OF THE INVENTION

The present invention provides a method for optimizing growth of microgreens, wherein the same can be utilized for cultivating and growing microgreens such that color, growth rate, yield, taste, and other parameters are optimized to obtain a superior product. The method includes planting individual microgreens within growing racks supported on vertically spaced shelves. An ideal distance may be calculated for the spacing of the shelves. An ideal wattage is calculated for one or more grow lights, which may be LEDs. The LEDs may include an adjustment mechanism to control output wattage. An ideal wavelength range is also applied, for enhancing desired colors in the final product. The microgreen seeds are planted in an organic nutrient solution derived from ocean water. A natural fungicide including ingredients such as molasses and lactic acid is applied, which allows room temperature to be raised to a calculated level, allowing for increased growth rates and yield without development of unwanted fungi. The method further includes calculating and applying an ideal light duration for each species, so that the color patterns are enhanced, yield is increased, and taste is improved.

Other objects, features and advantages of the present invention will become apparent from the following detailed description, taken in conjunction with the claims.

### DETAILED DESCRIPTION OF THE INVENTION

For the purposes of presenting a brief and clear description of the present invention, a preferred embodiment will be discussed as used for providing a method of optimizing microgreen growth that allows individuals to improve various properties of the microgreen product such as growth rate, color, yield, taste, and the like. While an example of the method is provided below as being used with either spaced shelves or adjustable LEDs, the present invention is not intended to be limited to any one particular embodiment, and the method can be applied in various environments and physical structures typically utilized for growing plants.

The method for growing microgreens is designed to be customizable so that in addition to enhancing common desirable traits such as yield and growth rate, the individual grower can adjust the method to enhance other desirable traits, such as color, for example. The method begins with providing a growing rack having an organic nutrient solution. The growing rack can be any object capable of supporting, either within itself or in a contacting container, a volume of organic nutrient solution, in which a microgreen can be planted. The organic nutrient solution is chosen to promote plant health, improve growth rate, and increase overall yield. To that end, the organic nutrient solution includes ocean water in one embodiment of the method. The natural minerals, electrolytes, and other compounds in the ocean water will increase the desirable properties of the microgreen growth once a microgreen plant is planted within the organic nutrient solution with the growing rack. The organic nutrient solution may include other ingredients to further improve and enhance the growth process.

The method can be applied across any desired growing setup depending on the growing environment and equipment available to the grower. For example, the growing racks may be spaced vertically along a support structure, with individual grow lights placed at the top of the support structure. This allows the grower to adjust the position of the microgreen plant with regard to its proximity to the light, allowing the grower to effectively adjust the intensity of the light received by the plants. Different microgreen species will thrive at different light intensities. For example, microgreens in the Amaranth family thrive under conditions with less light, while radishes can thrive under more intense lighting conditions. Different microgreens can be placed at different positions accordingly, in order to maximize growth properties of each species.

In other embodiments, the growing racks can be at a common height, such that the grow lights are placed above a common plane. The distance can be adjusted in this embodiment, or the grower may also utilize grow lights such as LEDs that are configured to be adjustable with regard to their output wattage. This allows the user to adjust the grow light itself rather than the position of the microgreens, which may be more convenient in some cases. Ideally, the LED or other grow lights include a maximum output wattage of 75 watts, as exceeding such could reduce the benefits of the present method. The distance between plant and light, or the light intensity, can thus be determined by observing outcomes and growth properties of different plant species under different wattage and distance conditions. If stunting or discoloration is observed, the grower can adjust the conditions accordingly, and use such adjustments in a future growth cycle to further optimize the growth process.

The grower may also determine a particular wavelength range for the grow light, depending on the desired effect on the particular species the grower wishes to have. For example, limiting the grow light to the blue light spectrum, between about 450 nanometers and 500 nanometers, will result in the cotyledon leaves and young true leaves having a more muted, less saturated, almost translucent coloration. This aesthetic property is often desirable in microgreens that are being used as garnishes or visual enhancements to a food dish. In contrast, applying a grow light that emits light across the entire visible spectrum, between 400 nanometers and 700 nanometers, will result in a more saturated coloration. This can indicate a higher nutrient content, which may be desirable for microgreens intended for use as a primary food source for their nutritional value.

Once the wavelength range, positioning and/or output power is determined, the grower can also apply the grow light or grow lights at a particular output power for a selected time interval. For example, some plants will yield better product when exposed to longer durations of light, while other plants will yield better product when exposed to shorter durations of light. In an additional effort to improve and optimize the growth of the microgreens, the grower may apply a natural fungicide to the microgreen plant. In one embodiment, the natural fungicide includes molasses and lactic acid as ingredients, both of which include fungicidal properties. The addition of the natural fungicides allow the plants to thrive at a higher moisture content and higher ambient temperature, since the plants would usually develop unwanted fungi in such conditions. As a result, the growth rate, yield, and other properties of the microgreen can be optimized without the negative effect of fungal growth. In general, the overall method provides many ways the user can affect the outcome of microgreen growth, by enhancing general desirable traits such as growth rate and yield, as well as specific traits for different product uses, such as different coloration types.

It is therefore submitted that the present invention has been described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, and all equivalent relationships to those described in the specification are intended to be encompassed by the present invention.

The foregoing is considered as illustrative only of the principles of the invention. Further, it is not desired to limit the invention to the exact construction and operation described, and accordingly, all suitable modifications and equivalents may be resorted to, falling within the scope of the invention.

I claim:

1) A method for growing microgreens comprising:
providing a growing rack having an organic nutrient solution;
providing a microgreen plant within the organic nutrient solution within the growing rack;
either one of calculating a distance of a grow light from the growing rack or adjusting an output power of the grow light to an optimal wattage;
applying the grow light at a particular output power for a selected time interval; and
applying a natural fungicide to the microgreen plant.

2) The method for growing microgreens of claim 1, wherein the organic nutrient solution includes ocean water as an ingredient.

3) The method for growing microgreens of claim 1, wherein the natural fungicide includes molasses and lactic acid as ingredients.

4) The method for growing microgreens of claim 1, wherein the grow light comprises an LED that emits light in the visible light spectrum within a wavelength range between 400 nanometers and 700 nanometers.

5) The method for growing microgreens of claim 1, wherein the grow light comprises an LED that emits light in the blue light spectrum within wavelength range between 450 nanometers and 500 nanometers.

6) The method for growing microgreens of claim 1, wherein the grow light is configured to output light at a maximum output level of 75 watts.
